(19) United States
(12) Patent Application Publication
(10) Pub. No.: US 2025/0264276 A1
(43) Pub. Date: Aug. 21, 2025

(54) Device for de-icing platform trolleys, and use

(71) Applicant: Deutsche Post AG, Bonn (DE)

(72) Inventors: Hendrik Meiner, Leipzig (DE); Elio Massimo Curti, Leipzig (DE); Jens Freund, Halle/Saale (DE)

(21) Appl. No.: 19/052,952

(22) Filed: Feb. 13, 2025

(30) Foreign Application Priority Data
Feb. 16, 2024 (DE) 10 2024 104 420.9

(51) Int. Cl. F26B 23/04; B64F 1/32; B64F 1/36; F26B 21/06

(52) U.S. Cl. CPC F26B 23/04; B64F 1/32; F26B 21/06; B64F 1/36

(57) ABSTRACT

The invention relates to the de-icing of platform trolleys. Proposed is a device for de-icing platform trolleys for transporting air-freight containers, the device having a passage for the platform trolleys, a stand and a de-icing means, arranged on the stand, having a hot-air blower that is directed towards the passage. The invention also relates to an arrangement, a use and a method.

The present application is based upon and claims the right of priority to DE Patent Application No. 10 2024 104 420.9, filed Feb. 16, 2024, the disclosure of which is hereby incorporated by reference herein in its entirety for all purposes.

The invention relates to the de-icing of platform trolleys. In particular, the invention relates in this context to a device, an arrangement, a use and a method.

Platform trolleys are used for transport. In winter, platform trolleys may ice up, or be covered with snow, or freeze, such that proper use is no longer possible. For this reason, platform trolleys have to be de-iced, i.e. freed from frozen water, or snow.

The techniques for de-icing platform trolleys known from the prior art include manual de-icing with tools or de-icing with chemical de-icing agents. These techniques are time-consuming, not very ergonomic and are harsh on the material on the platform trolleys.

Proceeding from this, the object of the invention is to provide solutions that improve the de-icing of platform trolleys.

This object is achieved by the subject-matter of the independent claims. Preferred developments of the invention are given in the sub-claims.

Proposed is a device for de-icing platform trolleys for transporting air-freight containers, having a passage for the platform trolleys, a stand and a de-icing means, arranged on the stand, having a hot-air blower that is directed towards the passage, particularly more than one hot-air blower or a plurality thereof. For example, the stand for providing the passage has a first side section and a roof section that is aligned transversely with respect to the first side section. For example, the de-icing system is arranged partly on the first side section and partly on the roof section. Alternatively or additionally, the first side section and the roof section each have one or more of the several hot air blowers.

For example, a device is proposed that has a frame and whose hot air blowers are directed from above and from at least one side onto the passage. This makes de-icing particularly effective and the device easy to use. Such a device has not been shown or suggested by the prior art.

In other words, for example, an appliance is proposed for removing ice or snow. The appliance is not only designed for drying and/or blowing away moisture, but is explicitly designed for de-icing, namely of platform trolleys, also referred to as a dolly, or dollies, which in turn are intended or designed for transporting air-freight containers. The appliance has a gateway or also a passage section, through which the platform trolleys can travel, or past which the platform trolleys can travel, in particular in order to be de-iced by the appliance. The appliance in this case has a means or more than one means for heating and blowing the heated air, which is/are, for example from above and laterally/from a side, directed towards the gateway, or the passage section, and is/are thus directed at the platform trolleys travelling through.

The management of a platform trolley fleet is an issue in the ground handling sector at airports. On a large airport apron there are numerous platform trolleys, for example hundreds or thousands. Platform trolleys are operated or parked like other vehicles. In particular, if parking spaces are not covered, but also during regular operation of the platform trolleys, the platform trolleys may become iced up. Here, the invention provides an advantageous remedy to at least temporarily remove the icing by the de-icing operation. The device proposes an advantageous solution to the problem of ice-covered platform trolleys in order to de-ice them. The device is optionally mobile and can be used at different locations as required. Together with the passage, the device provides a simple and intuitive accessory for de-icing platform trolleys. Time-consuming manual or chemical de-icing can thus be partially or completely eliminated.

In particular, the device is transportable, or mobile. The term “transportable” relates to the property of the device that it may be moved or transported comparatively easily from one place to another. This property implies that the size, weight and/or shape of the device is/are such that it is suitable for transport, for example manually, by vehicles and/or other means of transport. For example, the device can be rolled, moved and/or set up and dismantled between a mobility state and an operating states (e.g. within a day, within hours or even minutes).

De-icing denotes the process of removing ice, frost and/or snow from an item. Methods of de-icing may include the use of heat, chemical de-icing agents or mechanical means. De-icing aims in particular to ensure functional capability. The device is designed, in particular, for de-icing based on thermal principles, or by thermal/heat means.

The passage denotes, in particular, a section, opening and/or passage on the device, or stand, that allows a platform trolley to go through, or passed through or directly past it. The passage may relate to physical sections such as gates, frames, barriers and/or structures, in particular in which an opening is provided specifically in order to allow objects or hot air to go through, or be conveyed through. The passage is in particular large enough for platform trolleys to pass through, or be conveyed through. The passage may be realised in the shape of an archway, or as an (inverted) U-shape. The passage may also be arranged next to the device without a complete archway.

The stand denotes a structural construction, in particular a frame structure, main body and/or scaffolding, which serves to support, hold and/or position something. The stand may be produced from metal, wood or plastic. The stand relates, in particular, to the basic structure that forms the base or frame for the mounting of components, for example the de-icing means, or the hot-air blower. The stand may also be advantageously suitable for accommodating and/or enclosing components of the de-icing means. The stand may be provided with cladding, in at least some sections.

The de-icing means has the hot-air blower. In particular, the de-icing means utilises at least the principle of thermal de-icing, i.e. by means of heat/hot air/radiant heat to melt ice or snow. The de-icing means may also implement further principles, for example mechanical de-icing (e.g. stripping off and/or scraping off ice/snow) and/or chemical de-icing (e.g. by means of de-icing agents). In addition to the hot-air blower, the de-icing means may have further components, for example a controller, in particular for controlling the hot-air blower, a communication unit, in particular for communicating with operating personnel and/or with platform trolleys, and/or the like.

The hot-air blower is designed, in particular, to provide a hot-air flow. The hot-air blower may draw in ambient air, heat it and discharge it, in particular in a directed manner, as heated air. The ambient air may be drawn in such that a portion of the heated air that has already been used for de-icing is drawn in, in order to save energy; in this respect, drawing-in may be directed towards the passage.

The hot-air blower may be electrically operated and/or operated with a fuel, for example with gas fuel or liquid fuel. If fuel is used, the heated air may be mixed with exhaust gas; however, the exhaust gas may also be removed away from the heated air, or not directed towards the platform trolleys.

The hot-air blower typically has a main direction of flow, along which the heated air, or hot air/hot-air flow, is blown during operation. The hot-air blower, in particular its main direction of flow, is preferably directed towards the passage, for example at right angles to a direction of passage of the platform trolleys travelling through the passage, in order to de-ice platform trolleys. The hot-air blower may be arranged at the passage, in front of the passage and/or behind the passage. The hot-air blower may be arranged to the side of and/or laterally from and/or above the passage.

The de-icing means may have a plurality of hot-air blowers. For example, at least two, four, six or more hot-air blowers may be provided. Advantageously, at least nine hot-air blowers are provided. A plurality of hot-air blowers may be used to provide a plurality of hot air flows in order to de-ice a larger surface area and/or to de-ice more rapidly. Fail-safety is also increased should a defect occur in a hot-air blower. The capacity may also be easily changed by operating the plurality of hot-air blowers only as required.

The hot-air blower (or each of the hot-air blowers) may have a fan, in particular a centrifugal fan, and/or a heating element, in particular an electrical heating element and/or a PTC element. A centrifugal fan provides an easily directed air stream in a compact design, which additionally has an acceptable noise level. A suction side of the fan is preferably fitted with a grille and/or filter. The heating element, particularly preferably the PTC element, can be easily inserted into the air stream of a fan, or centrifugal fan. Also conceivable, however, are other electrical heating elements, and fans other than the centrifugal fan. PTC elements are known in the prior art. PTC elements have the advantage that they are basically self-regulating and are therefore well protected against overheating.

The hot-air blower (or each of the hot-air blowers) may have an outlet nozzle, or air guiding means. The outlet nozzle is intended, in particular, for directing the hot-air flow. The outlet nozzle may contain or be produced from metal, to protect against heat. The outlet nozzle is preferably fixed to the fan. The heating element may be arranged in the outlet nozzle, between the outlet nozzle and the fan, or at the outlet of the fan.

The hot-air blower (or the hot-air blowers) can preferably be operated electrically. In particular, the hot-air stream may be provided, at least substantially or exclusively, from electrical energy, or electricity. The hot-air blower may have an electrical fuse to prevent an overcurrent, or fire hazard. The device may have an electrical fuse for the de-icing means. In addition, the hot-air blower, or the de-icing means, is advantageously earthed via a protective conductor, or can be, or is earthed via a supply cable providing a protective conductor, in order to increase safety during operation.

At least two of the plurality of hot-air blowers may be such that they can be controlled separately from one another, i.e. for example the hot-air blower, or a controller, is configured accordingly to control the respective hot-air blowers separately from one another. In the case of electrical operability, in particular, controlling the hot-air blowers separately is easily achieved, and advantageous for saving energy and/or for providing a hot-air stream adapted to the respective platform trolley.

An energy supply means, having a supply connection for feeding electricity into the device, may be provided for the de-icing means. In particular, operation by means of alternating current, preferably three-phase alternating current, preferably at a frequency of 50 Hz or 60 Hz, is provided. For example, an operating voltage of at least 100 volts, 400 volts or more may advantageously be provided. The supply connection may be a plug-in connection for a mains cable. The supply connection is typically arranged on the device so that it is protected from splash water. The energy supply means may have an energy store such as an accumulator or a battery. The energy supply means and/or the de-icing means may have a rated power of at least 2.5 kW, 5 kW, 10 kW or 15 kW. The rated power in this case relates, for example, to the device as a whole or to individual components of the device. For example, the rated power relates to a single hot-air blower, to a group of hot-air blowers or to all hot-air blowers. In the case of comparatively high power, for example from 5 kW, a plurality of supply connections, or also energy supply means, may be provided.

In some embodiments, the hot-air blower is designed for burning fuel. If fuel is used, the energy supply means for the de-icing means may also have a fuel tank and/or a connection for feeding in fuel.

The platform trolley, also known as a dolly, or airport dolly, is to be understood as typically a vehicle, or vehicle trailer, that is suitable for transporting air-freight containers, for example ULD containers and/or ULD pallets. “ULD” stands for “Unit Load Device”. The platform trolley is a ground handling device at an airport. Air-freight containers are to be understood, in particular, as pallets and/or containers that may be used, for example, to load baggage, cargo and mail onto aircraft, in particular wide-body aircraft and/or narrow-body aircraft. Platform trolleys for air-freight containers, i.e. in particular airport dollies for ULD containers, or pallets, are flatbed trolleys and/or platforms having a plurality of wheels, roller rods or ball bearings that extend beyond the upper side, in order to facilitate, or enable, loading and unloading of the air-freight containers. As air-freight containers are therefore mounted in a movable manner on the platform trolleys, for example resting on ball bearings, these platform trolleys are in particular equipped with hinges, or locks, in order to secure the position of the air-freight containers when the platform trolleys are being moved.

The aviation industry has introduced air-freight containers as lightweight containers, or support platforms, that can be loaded onto aircraft and fly with their cargo. They must be of the lowest possible weight, and therefore do not have wheels or a sturdy basic structure. In addition, air-freight containers have strict dimensional standards that are based on the dimensions of an aircraft hold. Platform trolleys are therefore being developed in order to accommodate the dimensions of the air-freight container, the position of the hinges/brackets, the weak overall physical strength and the transport requirements.

Platform trolleys have, in particular, built-in rollers on the deck to assist the movement of air-freight containers. The rollers may be motorised, for example for moving forwards or backwards and/or sideways. Platform trolleys may have two sets of motorised rollers, one set of which can move the air-freight container forwards and backwards, and the other to the left and right. Precise movement is useful to align the centre of gravity of the air-freight container with the centre of the platform trolley, to prevent tipping over. Platform trolleys may have a rotating platform to rotate the air-freight container into the correct orientation. The platform may be motorised and rotatable. In particular, platform trolleys have brakes that can decelerate, or lock, the wheels of the platform trolley, for example when a tow bar of the platform trolley is in the parked (vertical) orientation, and can automatically release the platform trolley wheels when the tow bar is in the horizontal orientation.

It may be provided that a plurality of the hot-air blowers are arranged in a distributed manner along a direction of passage, the stand narrows upwardly and/or the stand is realised so as to be height-adjustable. The hot-air blowers may be arranged at different heights and/or in different sections along the direction of passage in order to cover as much surface area of the platform trolleys as possible, or to be directed at the platform trolleys for a long period of time. Because the frame tapers upwards and/or is realised at an angle to the passage, de-icing can be performed in a more space-saving and effective manner. It can thus also be ensured that the device stands more securely. For example, as viewed along a direction of passage, the device is longer, or broader, in a region close to the ground than in a region further away from the ground. This also keeps the centre of gravity as low as possible.

If the stand can be adapted to the height of platform trolleys passing through it, de-icing can be performed in a more space-saving and effective manner. For example, a height adjustment mechanism may be provided that is operated manually or by motor; however, it may also be explicitly provided that the device is not designed to be height-adjustable.

Preferably, to provide the passage, the stand has a first side section or a plurality thereof. A second side section or a plurality thereof may be provided. The second side section preferably is at least substantially parallel to the first side section. A roof section or a plurality thereof, aligned at least substantially transversely with respect to the first and/or second side section and/or extending out from the first and/or second side section may be provided. The sections, insofar as provided, are typically fixed to one another and/or realised in one piece with one another. It is conceivable for the sections, insofar as provided, to be detachably fixed to one another. It is conceivable for only the first side section and possibly the roof section to be provided, in particular such that the roof section is realised so as to overhang, or project over, the passage. It is also conceivable for a T-shape to be realised by the provision of two roof sections, which are in particular realised facing away from one another other on the first side section. In this way, de-icing may be performed on both sides of the first side section, or a passage may be realised on each side. In one particular case, the passage is provided on at least one side, to the side of the first side section. If necessary, neither the roof section nor the second side section are provided.

It is possible for the roof section to be fixed to the first side section and/or to the second side section, in particular such that the de-icing means, or the hot-air blower on the roof section, is at a fixed distance from the ground. For example, the roof section is arranged so that it cannot be adjusted in height relative to the side section(s).

The first side section, second side section and roof section may together form an archway and/or U-shape. The side sections may form legs of a U-shape, and the roof section form the crosspiece of a U-shape. Preferably, for an inverted U-shape, the U-legs face towards the bottom surface, or ground. Overall, a very flexible and additionally space-saving device is created with respect of different platform trolley designs. The mobility of the device is also advantageously improved.

An outlet nozzle of the de-icing means, in particular of the hot-air blower, or of a respective hot-air blower, may be orientated at least partially towards the ground and/or towards the respectively other side section. In particular, the outlet nozzle is directed at least substantially downwards, or faces towards the ground. In this way, particularly advantageously, the passage of platform trolleys can be detected for the purpose of de-icing.

Preferably, the passage has a width of at least 1.5 m or 2 m. ‘m’ is a measure for a size or distance and is an SI unit known as ‘meters’. The width of the passage may be at most 2 m, 2.5 m or 3 m. The width is typically determined as the overhanging length of the roof section and/or as the distance between the side sections. The passage may have a height of at least 1.5 m or 2 m. The height of the passage may be at most 2 m or 2.5 m or 3 m. The height is typically determined as the distance between the roof section and the ground and/or as the height of the first side section. With these dimensions, a platform trolley may be de-iced particularly effectively, while the device itself can be of a compact construction, and is optionally transportable.

The de-icing means may be arranged, at least partially, on one, more or all of the first side section, the second side section and/or the roof section or may be attached thereto. Particularly advantageously, the de-icing means is located in a distributed manner on at least two or all of the sections or is attached thereto, to enable de-icing of platform trolleys from a plurality of directions. A respective hot-air blower may be assigned to an individual section for this purpose. For example, there may be one, two, three or more hot-air blowers located on a respective section.

The de-icing means may be realised so as to be at least partially adjustable. For example, the de-icing means may be arranged so as to be adjustable, at least partially, on the first side section, the second side section and/or the roof section, in particular so as to be displaceable along the respective section and/or pivotable about it. Parts of the de-icing means, for example one or more individual hot-air blowers, may be adjustable while others are not adjustable, or are in a fixed orientation. The stand may be provided with a rail, along which the de-icing means, or the hot-air blower(s), may be adjusted, or moved. Particularly preferably, “adjustable” means that a controller can adjust the de-icing means. Adjustable means, in particular, that an orientation may be adjusted (for example by shifting or swivelling) manually and/or by motorised means. It is thus possible react adaptively to different platform trolleys and/or environmental conditions. This makes the device particularly flexible. In particular in combination with the fact that the device, in particular the stand and/or the roof section, may be height-adjustable, the adjustability of the de-icing means is particularly advantageous in order to create flexibility.

The device, in particular the de-icing means, may be equipped with sensor systems. Sensor systems serve, advantageously, to sense ambient conditions, such that de-icing may be performed effectively, i.e. as efficaciously as possible, and efficiently, i.e. with the greatest possible energy saving, in dependence on the items of information sensed by the sensors. For example, it may be provided that a platform trolley travelling through is de-iced only if the platform trolley is wet, covered with snow and/or ice, and/or if the ambient temperature is below a limit value (e.g. 3° C.).

A first sensor system may be provided, for recognising water, in particular ice or snow, in particular for recognising a quantity, a location and/or a state of aggregation of the water. By way of example, the first sensor system may include a camera, a temperature sensor, a humidity sensor and/or a thermographic sensor, by means of which icy, wet or cold regions can be reliably recognised. For example, a snow depth, a degree of icing and/or an ice cover may be recognized. It is conceivable that the thickness of an ice cover can be recognised.

A second sensor system may be provided, for sensing a temperature, in particular an ambient temperature and/or a temperature of a platform trolley. The second sensor system may include, by way of example, a camera, a temperature sensor, a thermographic sensor and/or a communication interface for accessing weather information, by which temperatures can be reliably sensed, or obtained.

One or more third sensor systems may be provided. For example, the third sensor system has a proximity sensor system, which is designed, in particular, for sensing platform trolleys. The third sensor system may be proximity-sensitive, for example at least with respect to platform trolleys. The third sensor system may alternatively or additionally be designed to sense a type, a shape, a deformation or damage and/or a position of a platform trolley. The third sensor system may sense, for example, a make, or intended use, of a platform trolley. For example, an identification feature, e.g. a barcode and/or QR code, of a platform trolley may be detected by sensors. The third sensor system may, for example, have a lidar sensor, a 3D sensor, a camera or a plurality of cameras, in particular stereo camera(s), a radar sensor, an ultrasonic sensor, a light barrier or similar.

In particular, a controller may be provided. The controller is preferably designed to control the de-icing means in dependence on a user input and/or in dependence on signals from one or more of the sensor systems described herein. The controller may be part of the de-icing means or realised separately from it, in particular as part of the device. The controller may have a communication interface that is designed, in particular, for internet-based communication. The controller may be designed for location sensing, for example to report the location of the controller, or device, to a control centre. The controller may be programmable, for example to programme operating times and/or operating modes. The controller may also be designed to monitor the device, for example to monitor a temperature in order to avoid overheating and/or to avoid operation at excessively high temperatures, in particular ambient temperatures. The controller may have an input device (e.g. keys, touchscreen, etc.) for receiving user inputs. The controller may have a display for showing items of information relevant to operation.

Particularly advantageously, the controller may be configured to adjust the de-icing means while the de-icing means is in operation. For example, a direction of a hot-air flow and/or a direction of radiation, for example thermal radiation and/or infrared radiation, may be altered by the adjustment. It is also possible for two or more of the heating means to be adjustable separately from one another. The adjustment may be effected in such a way that the de-icing means follows a platform trolley for the purpose of de-icing. To this extent, an advantageous acting in combination with one or more of the sensor systems described here is also achieved.

If platform trolleys are de-iced together with air-freight containers, which is possible, an adjustable de-icing means makes it possible to react flexibly to the contours of a platform trolley, or air-freight container.

In particular, the device, the de-icing means and/or the controller is/are splash-proof and/or designed for outdoor installation and/or has/have at least one seal. For example, the device may have a canopy arranged above the parts of the de-icing means and/or the controller.

The device may also have a protective housing, for example a sealed housing, in particular for the controller and/or controller components of the de-icing means.

Also proposed is an arrangement that includes the device and at least one platform trolley. The platform trolley is advantageously designed for transporting air-freight containers, or ULD containers. The arrangement serves as an advantageous system solution, for example for operators or those involved in airports.

Also proposed is use of the device described here for de-icing platform trolleys for transporting air-freight containers, in particular at a logistics hub and/or an airport.

Also proposed is use of a device realised as described above and/or having a hot-air blower directed towards a passage for platform trolleys. The use is intended for the de-icing of platform trolleys at a logistics hub and/or an airport. The platform trolleys are advantageously designed for transporting air-freight containers, or ULD containers. The use represents an advantageous innovation at logistics hubs, or airports, in order to ensure unproblematic winter operation of platform trolleys.

Also proposed is a method for de-icing platform trolleys. The method provides, in particular, that the de-icing is effected by means of a device that designed as described above and/or includes a hot-air blower directed towards a passage for platform trolleys. The method advantageously provides one or more of the following steps, preferably in the order indicated: Providing a platform trolley or a plurality of platform trolleys, in particular such that are covered with ice. Providing a hot-air flow and/or thermal radiation directed towards a passage for platform trolleys. Moving the platform trolley through the passage; the platform trolley or a plurality of platform trolleys may also be towed through the passage, or past the passage, by a tractor vehicle. Controlling, in particular activating, deactivating or modifying, the hot-air flow and/or thermal radiation in dependence on a user input and/or in dependence on signals from one or more sensor systems. The provision of the hot-air flow and moving of the platform trolley may also be effected simultaneously. The platform trolley may also be moved first, and then the hot-air flow provided. The hot-air flow is provided, in particular, for as long as the platform trolley is present in the region of the hot-air flow and/or the passage.

The method may be developed in that the platform trolley, in particular at least two, three or more platform trolleys, in particular coupled together, are towed. The platform trolley or trolleys may be towed by a tractor. The tractor may tow the platform trolley or trolleys through the passage. The tractor may be operated remotely and/or unmanned. It may be that the hot-air flow and/or thermal radiation is activated only once the tractor has passed through the passage. This enables de-icing to be effected in a particularly rapid and energy-saving manner.

Alternatively or additionally, it may be provided that the platform trolley or trolleys may be moved on a belt routed through the passage. The belt may convey the platform trolley or trolleys. The belt may be a conveyor belt and/or have a conveyor element, for example one or more conveyor rollers. It is also possible for the platform trolley or trolleys to be drawn along the belt, for example by a/the tractor and/or by a winch or the like.

It may be provided that, while moving, the respective platform trolley carries an air-freight container. To this extent, de-icing of the air-freight container on the platform trolley may also be provided. It is also possible, however, for an air-freight container to be basically de-iced on its own, or without a platform trolley, being moved through the passage by means of, for example, a belt and/or winch.

In the context of the disclosure, the term “or” used in parenthesis is intended principally to indicate alternative, basically equivalent and/or synonymous features or terms in order to convey more precisely the idea, or intent, of usage of a feature or term. “Or” used in parenthesis may always be replaced by “and/or”.

In the following, the invention is explained in further detail with reference to the drawings, on the basis of a preferred exemplary embodiment.

### IN THE DRAWINGS

FIG. 1 shows a perspective view of a transportable device for de-icing platform trolleys,

FIG. 2 shows the device from FIG. 1, in a further perspective view and together with a platform trolley,

FIG. 3 shows a tow combination of a tractor and three platform trolleys at an airport, and

FIG. 4 shows a perspective view of an arrangement with a device and a plurality of platform trolleys for air-freight containers.

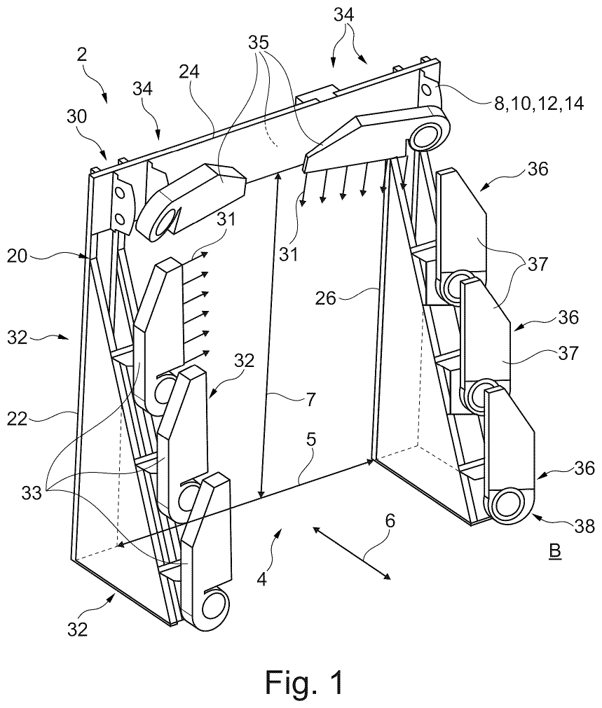

FIG. 1 shows a transportable device 2 for de-icing platform trolleys P, which are intended for transporting air-freight containers L. The device 2 has a passage 4 for the platform trolleys P, a cladded stand 20 and a de-icing means 30, arranged on the stand 20, having a plurality of hot-air blowers 32, 34, 36 that are each directed towards the passage 22. The hot-air blowers 32, 34, 36 each have a centrifugal fan, PTC elements and an outlet nozzle 33, 35, 37. These are electrically operated hot-air blowers 32, 34, 36, which can be controlled independently, or separately, from one another. It is represented schematically that two hot-air blowers 32, 34 each provide a hot-air flow 31.

An energy supply means 38 for the de-icing means 30 provides a supply connection for feeding in electricity. A mains cable, or an electric power cable, may be connected to the supply connection. In this case, for example, a “heavy current” connection, or a three-phase alternating current connection, is suitable for providing sufficient power. The operating voltage is preferably in the range of between 100 and 400 volts. An operating voltage of more than 100 volts, 200 volts or 400 volts is possible. The rated power of the device 2, with which hot-air flows 31 may be provided, is at least 2.5 kW, preferably 5 kW or more. The de-icing means 30 can in particular be regulated, for example in steps or continuously, in order to regulate the heat output, in particular by means of a controller 8, which is described in more detail below.

The plurality of hot-air blowers 32, 34, 36 are arranged along a direction of passage 6 and also distributed transversely with respect thereto, or in the vertical direction. The stand 20 narrows towards the top in order to improve stability, or reduce the tendency to tip over.

In the present case, as viewed along the direction of passage 6, the device 2 is longer in a region close to the ground than in a region further away from the ground B, in order to achieve a centre of gravity close to the ground.

In particular, the stand 20 may be realised so as to be height-adjustable, in order to reduce or increase the passage height. In the present case, the stand 20 is of a frame construction, for example provided by at least one metal profile, in particular an aluminium profile.

The hot-air blowers 32, 34, 36 may be adjusted on the stand 20, in particular by means of the controller 8, described in more detail below, for example in order to change the direction of the hot-air flow 31.

To provide the passage 4, the stand 20 has a first side section 22 having three hot-air blowers 32, a roof section 24, which has three hot-air blowers 34 and is aligned transversely with respect to the first side section 22 and extends from the first side section 22, and a second side section 26 having three hot-air fans 36. The second side section 26 is arranged substantially parallel to the first side section 22. The sections 32, 34, 36 are arranged in an arched, or inverted U, shape. The sections 32, 34, 36 are fixed to one another, in particular detachably connected to one another, for example screw-connected and/or detachably latched to one another.

The hot-air blowers 32, 34, 36 may be adjusted, or moved, or more precisely shifted and/or swivelled. One or more of the outlet nozzles 33, 35, 37 may be aligned, for example in to adapt individually to a platform trolley P and/or to follow it during operation.

The hot-air blowers 34 may be such that they can be shifted along the roof section 24 and/or swivelled about, or on, the roof section 24. Together with the roof section 24, a height adjustment may optionally be effected, which may ultimately also be equivalent to adjusting the hot-air blower 34.

The hot-air blowers 32 and 36 may be displaced along the respective side section 22 and 26, respectively, and/or swivelled about, or on, the side section 22 or 26, respectively. Together with the side section 22 or 26, respectively, a height adjustment may optionally be effected, which may ultimately also be equivalent to adjusting the hot-air blowers 32 and 36.

It is conceivable that the de-icing means 30, in particular the hot-air blower 32, 34, 36, may be adjusted, in particular by motor, on rails on the stand 20.

The stand 20 stands directly on the ground B. The device 2 may be shifted, and to this extent is transportable, or mobile. The device 1 is designed, in particular, to be placed, or set up, on a substantially flat, solid base. For example, an asphalted, or concreted, base is suitable. The device 1 does not necessarily have to be anchored or fastened in the ground B.

The outlet nozzles 35 are oriented substantially towards the ground B and are preferably directly transversely with respect to the direction of passage 6, in order to prevent the device 2 from tipping over due to the impulse resulting from the discharge of air. The outlet nozzles 33 and 37 are orientated substantially towards the respectively other side section 26 and 22, respectively, and/or substantially longitudinally towards the ground B.

The de-icing means 30 is arranged on all of the first side section 22, the second side section 26 and/or the roof section 24, in that respective hot-air blowers 32, 34, 36 are fixed on the respective sections 22, 24 and 26.

The device 2 has a controller 8 for controlling the de-icing means 30. The controller 8 has a communication unit that can communicate, for example, via mobile telephony and/or local telephony. The communication unit may communicate at least unidirectionally, i.e. receive or send items of information. In particular, the communication unit may communicate bidirectionally, i.e. receive and send items of information. The controller 8 is programmable.

The controller 8 may control the device 2 itself, in particular the de-icing means 30, in dependence on a user input. The user input may be made directly at the controller 8 and/or remotely, or wirelessly, or via the communication unit. The controller 8 may also control in dependence on signals from sensor systems 10, 12, 14.

It is conceivable for the controller 8 to be operated by a vehicle that is towing one or more of the platform trolleys P, and that therefore intends to travel through the passage 4.

For example, the controller 8 may effect an adaptation of the device 2, or de-icing means 30, for different platform trolleys P travelling through. For example, the temperature and/or output of a provided hot-air flow 31 may be matched to which platform trolley P (i.e. which type) is travelling through, the current ambient temperature and/or the quantity of snow/ice present on the platform trolley P. The controller 8 may regulate the de-icing means 30. A sequence may also be programmed. In the case of a height-adjustable device 2, or such a stand 20, the height adjustment may also be effected in dependence on sensor systems 10, 12, 14 and/or platform trolleys P travelling through. The outlet nozzles 33, 35, 37 may also be controlled and/or moved by the controller 8.

The device 2 also has a first sensor system 10 for recognising water, more specifically ice or snow, in particular for recognising a quantity, a location and/or a state of aggregation of the water. Additionally provided is a second sensor system 12, for sensing a temperature, in particular an ambient temperature and/or a temperature of a platform trolley P. Also provided is third sensor system 14, for sensing platform trolleys P, i.e. to sense, for example, whether there is a platform trolley P present in the passage 4. The third sensor system is proximity-sensitive, and can therefore in particular sense, or recognise, platform trolleys P. The third sensor system 14 may also recognise the type, shape and/or damage of a platform trolley P. The third sensor system 14 may also recognize the position of a platform trolley P in the passage 4. The third sensor system 14 has at least one camera.

The controller 8 is configured to adjust the de-icing means 30 in its operation and in dependence on one or more of the sensor systems 10, 12, 14. For example, the de-icing means 30 may be adjusted in dependence on the type, shape and/or position of a platform trolley. The hot-air blowers 32, 34, 36 may be adjusted individually, or separately.

The passage 4 is of a width 5 of 2 m±1 m and/or a height 7 of 2.5 m±1 m. The figures are not to scale in respect of width 5 and height 7.

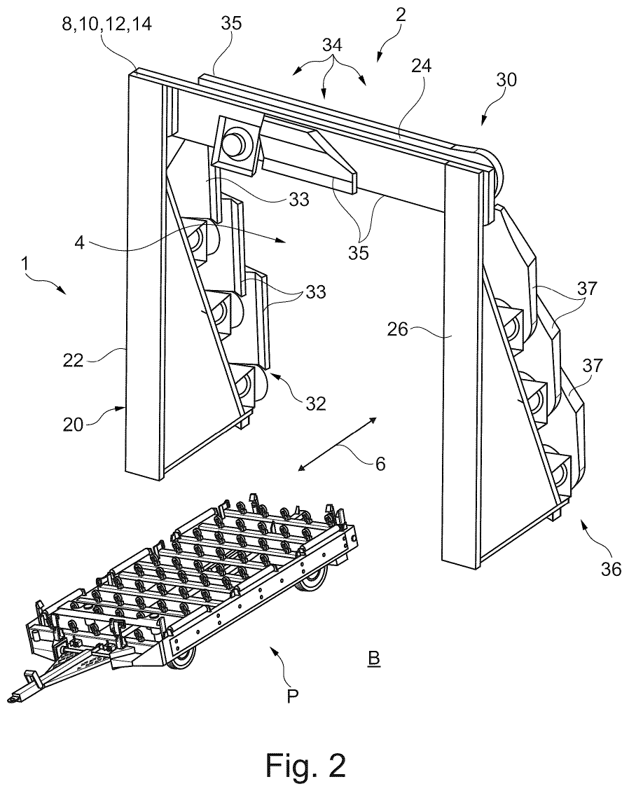

FIG. 2 shows an arrangement 1 with the device 2 already shown in FIG. 1 and with a platform trolley P, which is designed to transport air-freight containers, preferably ULD containers. The arrangement 1 is located at a logistics hub, or at an airport. The platform trolley 2 is arranged to be moved through the passage 4, along the direction of passage 6. The de-icing means 30 can then cause hot air to flow onto the platform trolley P in order to de-ice the platform trolley P. To this extent, a use of the device 2 for de-icing platform trolleys P is also shown.

With the arrangement 1 shown, a method for de-icing platform trolleys P can be performed. For this, a platform trolley P is provided. Also provided is a hot-air flow, directed towards the passage 4, which may be effected by means of the device 2. Additionally provided is moving of the platform trolley P through the passage 4 and along the direction of passage 6. The method also provides for controlling of the de-icing means 30, in particular the hot-air flow 31, for example in dependence on a user input and/or in dependence on signals from one or more of the sensor systems 10, 12, 14. To this extent, it may be sensed whether the platform trolley P is present in the passage 4, in order to provide, regulate and/or switch off the hot-air flow 31 in dependence thereon.

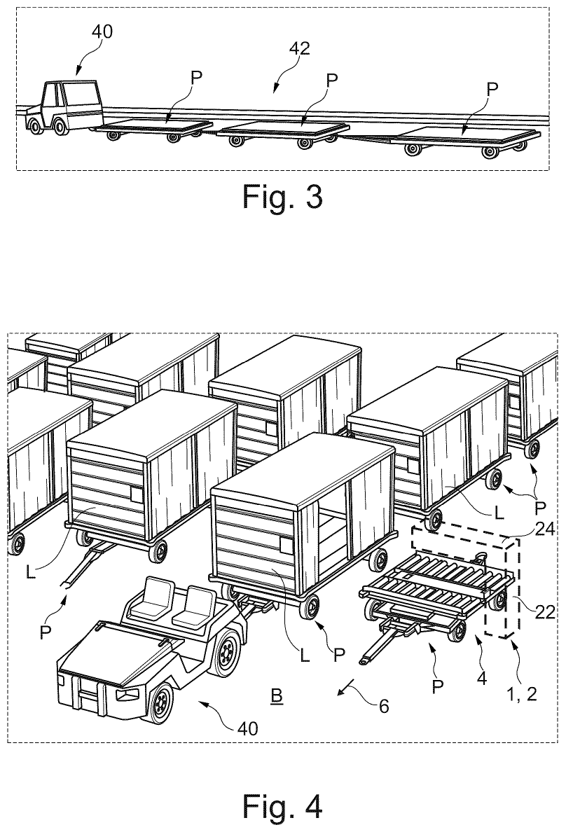

In the method, three platform trolleys P, for example, are towed through the passage 4 as a tow combination being towed by a tractor 40. FIG. 3 shows such a tow combination at an airport. The hot-air flow is provided, for example, only when the tractor 40 from the tow combination has passed through the passage 4. The de-icing means 30 in this case may automatically orient itself to a respective platform trolley P and/or air-freight container L, if present, and may be automatically switched on and off, in particular in dependence on the presence of water, or ice, on the platform trolley, temperature of the platform trolley, position of the platform trolley, and/or possibly other parameters. The tractor 40, as represented in FIG. 3 and also FIG. 4, is normally manned. However, it may also be an unmanned, remote-controlled and/or autonomous tractor 40.

FIG. 3 also shows, in the background behind the tow combination, a belt 42 that is realised as a conveyor belt. This may be used to move platform trolleys P through the passage 4.

Not shown is a variant in which a belt is provided on which the platform trolleys are conveyed and/or drawn through a passage. For example, platform trolleys may also be drawn through a passage by means of a winch.

FIG. 4 shows an arrangement 1 with a device 2 and a plurality of platform trolleys P, carrying air-freight containers L, at a logistics hub, in particular in the vicinity of or at an airport. A roof section of the device 2 overhangs a platform trolley P, in particular in order to direct as required a hot-air flow onto the platform trolley P, in the direction of the ground B, such that the platform trolley P is de-iced. In the present case, the device 2 has only one side section 22 and the roof section 24, which are fixed to one another. In the present case, there are no hot-air blowers located on the side section 22, but rather only on the roof section 24. The side section 22 is weighted, for example having a metal or mineral foot, in order as far as possible to keep the centre of gravity of the device 2 in the side section 22, and to prevent it from tipping over despite the projecting roof section 24. The passage 4 is formed by the side section 22 and the roof section 24. A direction of passage 6, along which a platform trolley P to be de-iced should be moved, extends transversely with respect to both the side section and the roof section 24.

FIG. 4 also shows a tow combination composed of a tractor 40 and at least three platform trolleys P, each carrying an air-freight container L. It is conceivable that air-freight containers L may also be de-iced by means of the device 2, for example air-freight containers L located on platform trolleys P or moved by a belt 42. To this extent, the tow combination together with air-freight containers L may be de-iced by means of the device 2.

With reference to FIG. 4, it is conceivable for a further roof section (not represented), oriented in a direction different from that of the roof section 24, in particular in the opposite direction, to extend out from the side section 22. In this way, balancing of the device 2 may also be achieved. To this extent, the device 2 with its sections may also be realised in a T-shape.

It is conceivable for one or more thermal radiators to be provided instead of or in addition to hot-air blowers 32, 34, 36. A thermal radiator may provide, for example, infrared radiation for de-icing, or be realised as an infrared radiator.

In examples not represented, mechanical device parts may also be provided to mechanically remove larger masses of ice or snow, in order to avoid having to apply the corresponding energy for melting.

### LIST OF REFERENCE DESIGNATIONS

1 arrangement
2 device
4 passage
5 width
6 direction of passage
7 height
8 controller
10 first sensor system
12 second sensor system
14 third sensor system
20 frame
22 side section
24 roof section
26 side section
30 de-icing means
31 hot-air flow
32 hot-air blower
33 outlet nozzle
34 hot-air blower
35 outlet nozzle
36 hot-air blower
37 outlet nozzle
38 energy supply means
40 tractor
42 belt
B ground
P platform trolley
L air-freight container

1. A device for de-icing platform trolleys for transporting air-freight containers, the device comprising:
a passage for the platform trolleys,
a stand, and
a de-icing means that is arranged on the stand and has a plurality of hot-air blowers directed towards the passage, wherein:
the stand includes, to provide the passage, a first side section and a roof section, which roof section is aligned transversely with respect to the first side section, and
the de-icing means is arranged, at least partially, on the first side section and on the roof section, and/or the first side section and the roof section each have one of the plurality of hot air blowers.

2. The device according to claim 1, the hot-air blower or hot-air blowers each having a centrifugal fan and/or a PTC element.

3. The device according to claim 1, the plurality of hot-air blowers configured to be operated electrically, and at least two of the plurality of hot-air blowers being such that they can be controlled separately from one another.

4. The device according to claim 1, comprising an energy supply means for the de-icing means, comprising a supply connection for feeding electricity into the device, the de-icing means comprises a rated power of at least 2.5 kW, 5 kW, 10 kW or 15 kW.

5. The device according to claim 1, a plurality of the hot-air blowers being arranged in a distributed manner along a direction of passage, the stand narrowing upwardly and/or the stand being realised so as to be height-adjustable.

6. The device according to claim 1, the stand, to provide the passage, comprising and a second side section, which is arranged substantially parallel to the first side section.

7. The device according to claim 1, an outlet nozzle of the de-icing means being orientated at least partially towards the respectively other side section.

8. The device according to claim 6, comprising:
a width of the passage of at least 1.5 m or 2 m, and
a height of the passage of at least 1.5 m or 2 m.

9. The device according to claim 7, the de-icing means being arranged on all of the first side section, the second side section and the roof section.

10. The device according to claim 1, the de-icing means being arranged so as to be adjustable on the first side section, the second side section and/or the roof section.

11. The device according to claim 10, the de-icing means being at least one of displaceable along the respective section and pivotable about it.

12. The device according to claim 1, comprising:
a first sensor system, for recognising water in the form of ice or snow, and for recognising a quantity, a location and/or a state of aggregation of the water, for example comprising a camera, and
a second sensor system, for sensing at least one of a temperature, an ambient temperature and a temperature of a platform trolley.

13. The device according to claim 1, comprising:
a third sensor system, which is proximity-sensitive, at least with respect to platform trolleys.

14. The device according to claim 1, comprising:
a/the third sensor system, which is designed to sense a type, a shape and/or a deformation of a platform trolley.

15. The device according to claim 1, comprising:
a controller, which is designed to control the de-icing means in dependence on a user input and/or in dependence on signals from one or more of the sensor systems.

16. The device according to claim 1, the controller being configured to adjust the de-icing means while the de-icing means is in operation, in order to at least one of alter a direction of a hot-air flow and adjust a temperature or power of a hot air flow provided to the platform trolleys.

17. An arrangement, comprising the device according to claim 1 and at least one platform trolley, which is designed for transporting air-freight containers or ULD containers.

18. A device, which is realized according to claim 1 and/or has a hot-air blower directed towards a passage for platform trolleys, for the de-icing of platform trolleys at a logistics hub and/or an airport, the platform trolleys being designed for transporting air-freight containers or ULD containers.

19. A method for de-icing platform trolleys by means of a device comprising hot-air blowers directed towards a passage for platform trolleys, which hot-air blowers are arranged to the side and above the passage, comprising the steps:
providing a platform trolley,
providing a hot-air flow directed towards a/the passage for platform trolleys,
moving the platform trolley through the passage, and
controlling, including at least one of activating, deactivating and modifying, the hot-air flow in dependence on a user input and/or in dependence on signals from one or more sensor systems.

20. The method according to claim 19, wherein at least one of:
the platform trolley, being towed by a tractor and being thereby moved through the passage;
the platform trolley being moved on a belt routed through the passage and being thereby conveyed by the belt or drawn along the; and
the platform trolley, while moving, carrying an air-freight container.
